(19) United States
(12) Patent Application Publication
(10) Pub. No.: US 2026/0024757 A1
(43) Pub. Date: Jan. 22, 2026

(54) SOLID-STATE BATTERY

(71) Applicant: TOYOTA JIDOSHA KABUSHIKI KAISHA, Toyota-shi Aichi-ken (JP)

(72) Inventors: Ryo Asakura, Sunto-gun Shizuoka-ken (JP); Shinya Shiotani, Nagoya-shi Aichi-ken (JP); Ximeng Li, Susono-shi Shizuoka-ken (JP); Sakina Kaneko, Fujisawa-shi Kanagawa-ken (JP)

(73) Assignee: TOYOTA JIDOSHA KABUSHIKI KAISHA, Toyota-shi Aichi-ken (JP)

(21) Appl. No.: 18/661,976

(22) Filed: May 13, 2024

(30) Foreign Application Priority Data
May 16, 2023 (JP) 2023-080746

(51) Int. Cl. H01M 4/46; H01M 4/36; H01M 10/052; H01M 10/0562

(52) U.S. Cl. CPC H01M 4/466; H01M 4/366; H01M 10/052; H01M 10/0562; H01M 2300/0068

(57) ABSTRACT

The present disclosure provides a solid-state battery with high cycle characteristics. In the solid-state battery of the present disclosure, a positive electrode current collector layer, a positive electrode active material layer, a solid electrolyte layer, a negative electrode active material layer, and a negative electrode current collector layer are laminated in this order. The negative electrode active material layer of the solid-state battery of the present disclosure comprises a gallium-based layer containing gallium or lithium-gallium alloy, and a magnesium-based layer containing magnesium or lithium-magnesium alloy. The gallium-based layer is arranged on the side of the solid electrolyte layer, and the magnesium-based layer is arranged on the side of the negative electrolyte layer.

### CROSS-REFERENCE TO RELATED APPLICATIONS

This application claims priority to Japanese Patent Application No. 2023-080746 filed May 16, 2023, the entire contents of which are herein incorporated by reference.

### FIELD

The present disclosure relates to a solid-state battery.

### BACKGROUND

In recent years, with the rapid spread of information-related devices and communication devices such as personal computers, video cameras, and mobile phones, the development of batteries to be used as power sources has become important. In the automotive industry and the like, development of high-output and high-capacity batteries for electric vehicles or hybrid vehicles is being promoted.

Among batteries, the lithium secondary batteries are attracting attention because they contain metallic lithium, which has the highest ionization tendency among metals, as negative electrode active material in the negative electrode active material layer, so there is a large potential difference with the positive electrode active material layer, and a high output voltage can be obtained.

In addition, in recent years, solid-state batteries having a solid electrolyte as an electrolyte have been attracting attention. Solid-state batteries are less likely to cause decomposition of the electrolyte due to overcharging of the battery, and have higher cycle characteristics and energy density than batteries use an electrolytic solution.

PTL 1 discloses a solid-state battery containing a β-monophasic alloys of metal lithium and metal magnesium as a negative electrode active material.

PTL 2 discloses a secondary battery in which a negative electrode active material layer includes gallium and a resin.

PTL 3 discloses an all-solid-state lithium battery in which at least one lithium alloy layer selected from lithium-gallium alloy, lithium-indium alloy, lithium-antimony alloy, and lithium-bismuth alloy is provided at the interface between a solid electrolyte and a lithium negative electrode.

### CITATION LIST

### Patent Literature

[PTL 1] Japanese Unexamined Patent Publication (Kokai) No. 2020-184513
[PTL 2] Japanese Unexamined Patent Publication (Kokai) No. 2015-018799
[PTL 3] Japanese Unexamined Patent Publication (Kokai) No. 61-126770

### SUMMARY

### Technical Problem

As negative electrode active materials, there is still room for improvement in the cycling properties of solid-state batteries containing materials capable of forming alloys with metallic lithium.

Therefore, An object of the present disclosure is to provide a solid-state battery with high cycle characteristics.

### Solution to Problem

The present disclosers have discovered that the above object can be achieved by the following techniques.

### Aspect 1

A solid-state battery in which a positive electrode collector layer, a positive electrode active material layer, a solid electrolyte layer, a negative electrode active material layer, and a negative electrode collector layer are laminated in this order,
wherein the negative electrode active material layer comprises a gallium-based layer containing gallium or lithium-gallium alloy, and a magnesium-based layer containing magnesium or lithium-magnesium alloy,
wherein the gallium-based layer is arranged on the side of the solid electrolyte layer, and
wherein the magnesium-based layer is arranged on the side of the negative electrode collector layer.

### Aspect 2

The solid-state battery according to Aspect 1, wherein in a charged state, the gallium-based layer contains the lithium-gallium alloy, and the magnesium-based layer contains the lithium-magnesium alloy.

### Aspect 3

The solid-state battery according to Aspect 1 or 2, wherein in a discharged state, the gallium-based layer contains the gallium, and the magnesium-based layer contains the magnesium.

### Aspect 4

The solid-state battery according to any one of Aspects 1 to 3, wherein the negative electrode active material layer is composed only of the gallium-based layer and magnesium-based layer.

### Aspect 5

The solid-state battery according to any one of Aspects 1 to 4, wherein the solid electrolyte layer is a sulfide solid electrolyte layer.

### Aspect 6

The solid-state battery according to any one of Aspects 1 to 5, wherein the gallium-based layer and the magnesium-based layer are gallium-magnesium bilayer vapor-deposited foils.

### Effects

According to the present disclosure, a solid-state battery with high cycle characteristics can be provided.

### BRIEF DESCRIPTION OF DRAWINGS

FIG. 1 is a graph showing the cycle characteristics at 25° C. of the cells of Example 1 (Ga—Mg bilayer), Comparative Example 1 (Ga), and Comparative Example 2 (Mg).

FIG. 2 is a cross-sectional SEM secondary-electron image of the negative electrode active material layer of Example 1 after the initial charge and discharge at 60° C.

FIG. 3A is an image showing the result of EDX mapping analysis by SEM-EDX of the negative electrode active material layer of Example 1 after the first charge and discharge at 60° C. for Mg element.

FIG. 3B is an image showing the result of EDX mapping analysis by SEM-EDX of the negative electrode active material layer of Example 1 after the first charge and discharge at 60° C. for Ga element.

FIG. 3C is an image showing the result of EDX mapping analysis by SEM-EDX of the negative electrode active material layer of Example 1 after the first charge and discharge at 60° C. for O element.

FIG. 3D is an image showing the result of EDX mapping analysis by SEM-EDX of the negative electrode active material layer of Example 1 after the first charge and discharge at 60° C. for S element.

FIG. 4 is a graph showing the cycle characteristics of the cells of Example 1 (Ga—Mg bilayer), Comparative Example 1 (Ga), and Comparative Example 2 (Mg) at 25° C. at 0.60 mA/cm² after the first charge and discharge.

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

### <<Solid-State Battery>>

In the solid-state battery of the present disclosure, a positive electrode current collector layer, a positive electrode active material layer, a solid electrolyte layer, a negative electrode active material layer, and a negative electrode current collector layer are laminated in this order. The negative electrode active material layer of the solid-state battery of the present disclosure comprises a gallium-based layer containing gallium or lithium-gallium alloy, and a magnesium-based layer containing magnesium or lithium-magnesium alloy. The gallium-based layer is arranged on the side of the solid electrolyte layer, and the magnesium-based layer is arranged on the side of the negative electrolyte layer.

As a method for improving the energy-density of solid-state batteries, a method of using metallic lithium (Li) as a negative electrode active material and making it anode-free can be mentioned. However, the present inventor have found that cycle characteristics may be deteriorated in anode-free solid-state batteries. Without intending to be bound by any theory, the reason therefor is presumed to be that the disappearance of Li in the negative electrode active material layer during discharge causes separation at the interface between the solid electrolyte layer and the negative electrode active material layer.

As shown in PTL 1, an anode-free solid-state battery is known that includes a β-monophasic alloy of metal Li with metal magnesium (Mg) as a negative electrode active material. The present inventors have found that, in addition to the Mg-based layer containing such metallic Mg or lithium-magnesium (Li—Mg) alloy, arranging a Ga-based layer containing metallic gallium (Ga) or lithium-gallium (Li—Ga) alloy between the solid electrolyte layer and Mg-based layer to make the negative electrode active material layer into a bilayer improves the cycle characteristics of the battery comprising such a negative electrode active material layer. Without intending to be bound by any theory, the reason therefor is presumed to be that the Ga-based layer is retained between the solid electrolyte layer and the Mg-based layer, thereby the separation at the interface between the negative electrode active material layer and the solid electrolyte layer can be suppressed even at the end of discharge of the battery.

In the solid-state battery of the present disclosure, a positive electrode current collector layer, a positive electrode active material layer, a solid electrolyte layer, a negative electrode active material layer, and a negative electrode current collector layer are laminated in this order.

### <Positive Electrode Current Collector Layer>

As a positive electrode current collector, known metals that can be used as a current collector for solid-state batteries can be used. Examples of such metals may include metallic materials containing one or more elements selected from the group consisting of Cu, Ni, Al, V, Au, Pt, Mg, Fe, Ti, Co, Cr, Zn, Ge, and In.

The form of the positive electrode current collector is not particularly limited, and can be in various forms, such as foil-like and mesh-like.

### <Positive Electrode Active Material Layer>

The positive electrode active material layer comprises a positive electrode active material, and may optionally contain a solid electrolyte, a conductive material, a binder, and the like.

### (Positive Electrode Active Material)

There is no particular limitation on the type of a positive electrode active material, and any material that can be used as an active material for solid-state batteries can be adopted. The positive electrode active material may contain a lithium element or may not contain a lithium element.

Examples of the positive electrode active material containing the lithium element include metallic lithium (Li), lithium alloy, LiCoO₂, LiNiₓCo₁₋ₓO₂ (0<x<1), LiNi_{1/3}Co_{1/3}Mn_{1/3}O₂, LiMnO₂, heterologous element-substituted Li—Mn spinel (e.g., LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄), lithium titanate (e.g., Li₄Ti₅O₁₂), metal lithium phosphate (e.g., LiFePO₄, LiMnPO₄, LiCoPO₄, and LiNiPO₄), LiCON, Li₂SiO₃, and Li₄SiO₄.

Examples of the lithium-alloy include Li—Au, Li—Mg, Li—Sn, Li—Si, Li—Al, Li—Ge, Li—Sb, Li—B, Li—C, Li—Ca, Li—Ga, Li—As, Li—Se, Li—Ru, Li—Rh, Li—Pd, Li—Ag, Li—Cd, Li—Ir, Li—Pt, Li—Hg, Li—Pb, Li—Bi, Li—Zn, Li-TI, Li—Te, Li—At, and Li—In.

Examples of the positive electrode active material not containing the lithium element include transition metal oxide (e.g., V₂O₅, and MoO₃), sulfur, TiS₂, Si, SiO₂, and lithium storage intermetallic compound (e.g., Mg₂Sn, Mg₂Ge, Mg₂Sb, and Cu₃Sb).

The shape of the positive electrode active material is not particularly limited, but may be particulate.

A coating layer containing Li ion conductive oxide may be formed on the surface of the positive electrode active material. This is because the reaction between the positive electrode active material and the solid electrolyte can be suppressed.

Examples of Li ion conductive oxide include LiNbO₃, Li₄Ti₅O₁₂, and Li₃PO₄. The thickness of the coat layer is, for example, 0.1 nm or more, and may be 1 nm or more. On the other hand, the thickness of the coat layer is, for example, 100 nm or less, and may be 20 nm or less. The coverage of the coating layer on the surface of the positive electrode active material is, for example, 70% or more, and may be 90% or more.

### (Solid Electrolyte)

Examples of the solid electrolyte include a sulfide solid electrolyte and an oxide-based solid electrolyte.

Examples of the sulfide solid electrolyte include Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅, and Li₃PS₄. The above description of “Li₂S—P₂S₅” means a material made using a raw material composition containing Li₂S and P₂S₅, and the same applies to other descriptions. In addition, “X” in the above LiX indicates a halogen element. One or more types of LiX may be contained in the raw material composition containing the above LiX When two or more types of LiX are contained, the mixing ratio of two or more types is not particularly limited.

Examples of the oxide-based solid electrolyte include Li_{6.25}La₃Zr₂Al_{0.25}O₁₂, Li₃PO₄, and Li_{3+X}PO₄₋ₓNₓ (0<x≤3).

The rate of the solid electrolyte in the positive electrode active material layer is not particularly limited, but may be, for example, 1% by mass to 80% by mass, assuming that the total mass of the positive electrode active material layer is 100% by mass.

### (Conductive Aid)

As the conductive aid, known materials can be used, such as carbon material, and metal particle. Examples of the carbon material include at least one selected from the group consisting of carbon black, such as acetylene black and furnace black, carbon nanotube, and carbon nanofiber. Among these, in some embodiments, at least one type selected from the group consisting of carbon nanotube and carbon nanofiber is selected

from the viewpoint of electron conductivity. The carbon nanotube and the carbon nanofiber may be a VGCF (vapor grown carbon fiber). Examples of metal particle include particles such as Ni, Cu, Fe, and SUS.

The content of the conductive aid in the positive electrode active material layer is not particularly limited.

### (Binder)

Examples of the binder include acrylonitrile butadiene rubber (ABR), butadiene rubber (BR), polyvinylidene fluoride (PVdF), and styrene butadiene rubber (SBR)

The content of the binder in the positive electrode active material layer is not particularly limited.

The thickness of the positive electrode active material layer is not particularly limited.

### <Solid Electrolyte Layer>

The solid electrolyte layer contains a solid electrolyte and optionally a binder.

### (Solid Electrolyte)

The above descriptions relating to the positive electrode active material layer of the present disclosure can be referenced regarding the solid electrolyte.

The solid electrolyte may be used in one or more types. When using two or more types of solid electrolytes, two or more types of solid electrolytes may be mixed, or a multilayer structure may be formed by forming a layer of each of two or more solid electrolytes.

The rate of the solid electrolyte in the solid electrolyte layer is not particularly limited, but is, for example, 50% by mass or more, and may be 60% by mass or more and 100% by mass or less, or 70% by mass or more and 100% by mass or less, and may be 100% by mass.

### (Binder)

The solid electrolyte layer can also contain a binder from the viewpoint of developing plasticity. The above descriptions relating to the positive electrode active material layer of the present disclosure can be referenced regarding the binder. In order to easily achieve high output, the amount of a binder to be contained in the solid electrolyte layer may be 5% by mass or less from the viewpoint of preventing excessive aggregation of the solid electrolyte and enabling formation of a solid electrolyte layer having uniformly dispersed solid electrolyte.

The thickness of the solid-electrolyte layers is not particularly limited, and is usually 0.1 μm or more and 1 mm or less.

### <Negative Electrode Active Material Layer>

The negative electrode active material layer comprises a Ga-based layer and a Mg-based layer.

### (Gallium-Based Layer)

The Ga-based layer contains metallic Ga or Li—Ga alloy as a negative electrode active material.

The metallic Ga may be a metal Ga itself or a material obtained by vapor-depositing metallic Ga.

The Li—Ga alloy may be alloy generated by charging a solid-state battery containing the negative electrode active material layer of the present disclosure, or an alloy prepared separately.

Examples of methods for generating a Li—Ga alloy by charging a solid-state battery include the following methods. First, a battery precursor having a positive electrode active material layer containing at least one positive electrode active material selected from the group consisting of a metallic Li, a Li alloy and a Li compound, a solid electrolyte layer, a metallic Ga layer, and a negative electrode current collector layer in this order is prepared. By charging this battery precursor, Li ion that has moved from the positive electrode active material layer to the metallic Ga layer react with the metallic Ga in the metallic Ga layer, thereby obtaining a Li—Ga alloy. The battery precursor may be charged and discharged more than once from the viewpoint of alloying all the metallic Ga in the metallic Ga layers with the metallic Li. The number of charges and discharges is not particularly limited, and can be appropriately set according to the thickness of the metallic Ga layer.

The Ga-based layer is arranged on the side of the solid electrolyte layer. By arranging Ga-based layer between the solid electrolyte layer and the Mg-based layer described below to form a bilayer negative electrode active material layer, the cycle characteristics of a battery including such a negative electrode active material layer are improved.

The Ga-based layer may contain other conventionally known negative electrode active materials as long as it contains a metallic Ga or a Li—Ga alloy as a negative electrode active material as a main component. In the present disclosure, the main component means a component contained in an amount of 50% by mass or more when the total mass of Ga-based layer is set to 100% by mass.

### (Magnesium-Based Layer)

The Mg-based layer contains metallic Mg or Li—Mg alloy.

The metallic Mg may be a metallic Mg itself or a material obtained by vapor-depositing metallic Mg.

The Li—Mg alloy may be alloy generated by charging a solid-state battery containing the negative electrode active material layer of the present disclosure, or an alloy prepared separately.

The above descriptions relating to the methods for generating the Li—Ga alloy of the present disclosure can be referenced regarding methods for generating the Li—Mg alloy by charging solid-state batteries.

The Mg-based layer is arranged on the side of the negative electrode collector layer.

The Mg-based layer may contain other conventionally known negative electrode active materials as long as it contains a metallic Mg or a Li—Mg alloy as a negative electrode active material as a main component. In the present disclosure, the main component means a component contained in an amount of 50% by mass or more when the total mass of Mg-based layer is set to 100% by mass.

### (Solid Electrolyte, Conductive Aid, and Binder)

The negative electrode active material layer may comprise a solid electrolyte, a conductive aid, a binder. The above descriptions relating to the positive electrode active material layer of the present disclosure can be referenced regarding the solid electrolyte, the conductive aid, and the binder.

The thickness of the negative electrode active material layer is not particularly limited, but may be 30 nm or more and 50 μm or less.

### <Negative Electrode Current Collector Layer>

The negative electrode current collector may be materials not alloyed with Li, such as SUS, copper, and nickel.

Examples of the form of a negative electrode current collector include foil-like and plate-like.

The planar view shape of the negative electrode current collector may include, but is not limited to, for example, circular, elliptical, rectangular, and optional polygonal shape.

The thickness of the negative electrode current collector varies depending on the shape, but may be, for example, 1 μm to 50 μm or 5 μm to 20 μm.

### EXAMPLES

### <<Production of Battery>>

### <Preparation of Positive Electrode Active Material Layer>

Using butyl butyrate as a solvent, a positive electrode mixture slurry was prepared with a weight-composition ratio of lithium nickelate (NCA):solid electrolyte:binder:conductive aid=84.7:13.4:0.6:1.27, coated on an aluminum (Al) foil with a coating gap of 225 μm, and then temporarily dried at 60° C., and dried at 165° C. for 1 h. Thus, a positive electrode active material layer with a basis weight of 18.7 mg/cm² and a designed capacity 3.0 mAh/cm² was obtained.

### <Preparation of Solid Electrolyte Layer>

Using butyl butyrate as a solvent, a solid electrolyte slurry was prepared with a weight composition ratio of solid electrolyte:binder=92.6:7.4, coated on a release film with a coating gap of 325 μm, and then temporarily dried at room temperature for about 3 h and dried at 165° C. for 1 h. Two sheets with a 14.5 mm were punched out from the dried coated foil, and the coated surfaces were overlapped and pressed at 7 t. The release film was peeled off after pressing to obtain a self-supporting sulfide solid electrolyte layer.

### <Preparation of Negative Electrode Active Material Layer>

As the negative electrode active material layers, gallium (Ga) vapor-deposited foil (thickness: 0.84 μm), magnesium (Mg) vapor-deposited foil (thickness: 1.0 μm), and Ga—Mg bilayer vapor-deposited foil (thickness of Ga vapor-deposited foil: 1.0 μm, thickness of Mg vapor-deposited foil: 1.0 μm) were prepared.

### Assembly of Cell

### Comparative Example 1

The produced positive electrode active material layer was punched out with φ11.28 mm. Further, Ga vapor-deposited foil as a negative electrode active material layer was punched out with φ14.5 mm. A self-supporting solid electrolyte layer of @14.5 mm was arranged between the positive electrode active material layer and the negative electrode active material layer. Al foil was used as the positive electrode current collector, and Ni as the negative electrode current collector. These were vacuum sealed within a laminate film. The sealed cell was isostatically pressed at 392 MPa using cold isostatic pressing (CIP) to produce the laminated cell. The produced cell was restrained at 1 MPa using a constant pressure jig into which a spring was inserted so that the restraint pressure remained constant regardless of changes in the volume of the cell. Thus, a cell of Comparative Example 1 was obtained.

### Comparative Example 2

A cell of Comparative Example 2 was obtained in the same manner as in Comparative Example 1 except that the negative electrode active material layer was a Mg vapor-deposited foil.

### Example 1

A cell of Example 1 was obtained in the same manner as in Comparative Example 1 except that the negative electrode active material layer was a Ga—Mg bilayer vapor-deposited foil. Ga vapor-deposited foil was arranged on the side of the solid electrolyte layer, and Mg vapor-deposited foil was arranged on the side of the negative electrode current collector layer.

### <<Evaluation>>

### <Measurement of Charge and Discharge Curve>

In a constant current (current density: 0.15 mA/cm², 0.05 C equivalent)-constant voltage (cut-off current density: 0.03 mA/cm², 0.01 C equivalent) test, with a cut-off voltage in the range of 4.2 V to 3.0 V, initial charge and discharge of the restrained cell was carried out at 60° C., and a charge and discharge curve was acquired.

### <SEM-EDX Measurement>

SEM observation using a secondary-electron image and EDX mapping were performed at an applied voltage of 5 kV on the cross section of Ga—Mg bilayer vapor-deposited foil after initial charge at 60° C.

### <Measurement of Cycle Characteristics>

After the initial charge and discharge at 60° C., cycle characteristics in constant current (current density: 0.60 mA/cm², 0.05 C equivalent)-constant voltage (only when charging, cut-off current density: 0.03 mA/cm², 0.01 C equivalent) test were measured at 25° C. with a cut-off voltage in the range of 4.2 V to 3.0 V. Because Ga has a low melting point (melting point: 29.7° C.), in the cyclic characteristics test of the cell of Comparative Example 1 in which the negative electrode active material layer was Ga vapor-deposited foil, the initial charge and discharge was carried out at 25° C.

### Results

### <Measurement Result of Charge and Discharge Curve>

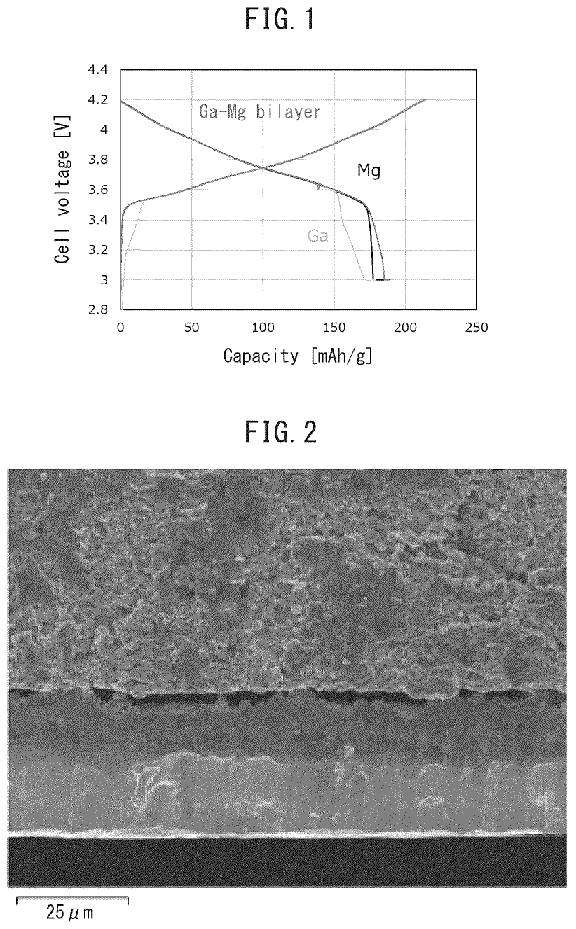

FIG. 1 shows the initial charge and discharge curve at 60° C. at a current density of 0.15 mA/cm² (to C/20) in cells of each example.

As shown in FIG. 1, the charge capacity and discharge capacity were 213 to 215 mAh/g and 179 to 189 mAh/g, respectively, based on the positive electrode active material. In the cell of Comparative Example 1 using Ga vapor-deposited foil as the negative electrode active material layer, the cell voltage was lower than that of Mg vapor-deposited foil in the region of 3.2 V to 3.5 V at the beginning of charge and the region of 3.6 V to 3.0 V at the end of discharge. This suggests that in the cell of Comparative Example 1, insertion of Li into Ga and alloying occur at the beginning of charge before deposition of metallic lithium (Li) at the negative electrode potential ˜0V vs Li, and deposition of Li from Ga occurs at the end of discharge.

In contrast, in the cell of Example 1 using Ga—Mg bilayer vapor-deposited foil as the negative electrode active material layer, in the discharge curve at 3.5 V or less, additional reversible capacity was observed compared to the cell of Comparative Example 2 using Mg vapor-deposited foil as the negative electrode active material layer, and the reversible capacity derived from the constant voltage step at the lower limit cut-off voltage 3.0V was decreased. This suggests that the presence of the Ga layer in the Ga—Mg bilayer vapor-deposited foil does not cause drop of cell-voltage at the beginning of charge, and allows more deposition of Li in the constant current step at the end of discharge.

### <Measurement Result of SEM-EDX>

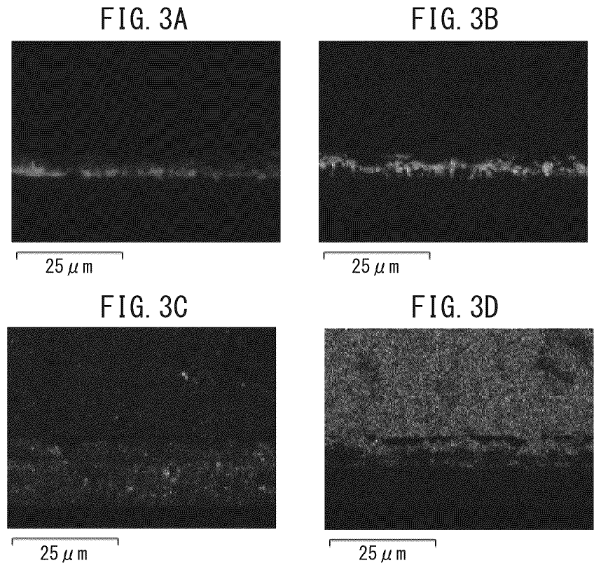

FIG. 2 and FIG. 3 show the cross-sectional SEM secondary-electron images and EDX mapping analysis results of the cell of Example 1 using Ga—Mg bilayer vapor-deposited foil as the negative electrode active material layer after the first charge and discharge at 60° C.

As shown in FIGS. 2 and 3, a distribution rich Mg, Ga, and S was confirmed in order from the lowest negative electrode current collector layer. This indicates that Ga-based layer exists between the Mg-based layer and the solid electrolyte layer even after insertion and deposition of Li due to initial charge and discharge. It is thought that this Ga-based layer is a Li deposition reaction field at the end of discharge, and contributes to maintaining the negative electrode active material layer-solid electrolyte interface and increasing reversible capacity in the constant current step.

### <Measurement Results of Cycle Characteristics>

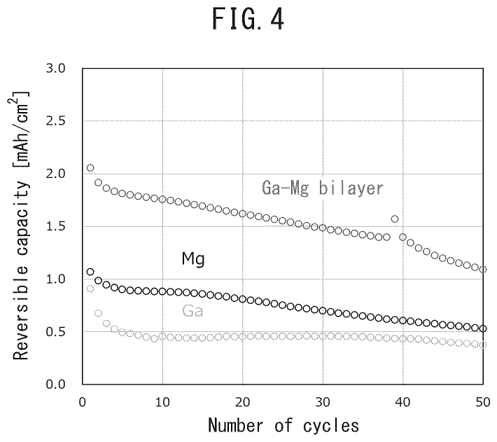

FIG. 4 shows the results of the 25° C. cycle characteristics at 0.60 mA/cm² (to C/5) after the initial charge and discharge of the cells of each example. Table 1 shows reversible capacity after 50 cycles.

TABLE 1

| | | Reversible capacity |
|---|---|---|
| | Negative electrode | after 50 cycles |
| | active material | (25° C.) |
| | layer | [mAh/cm²] |
| Comparative Example 1 | Ga vapor-deposited foil | 0.37 |
| Comparative Example 2 | Mg vapor-deposited foil | 0.53 |
| Example 1 | Ga—Mg bilayer | 1.09 |
| | vapor-deposited foil | |

As shown in FIGS. 4 and 1, the cell of Example 1 using Ga—Mg bilayer vapor-deposited foil as the negative electrode active material layer had a larger reversible capacity than the cell of the comparative example. In the cell of Example 1, both the reversible capacity after 1 cycle and the reversible capacity after 50 cycles were approximately twice that of Comparative Example 2, which had a larger reversible capacity among the comparative examples.

Also, as shown in FIG. 4 and Table 1, the cell of Comparative Example 2 using Mg vapor-deposited foil had a larger reversible capacity than the cell of Comparative Example 1 using Ga vapor-deposited foil as the negative electrode active material layer. From this, in a cell comprising the negative electrode active material layer of the present disclosure, it is considered that the reversible capacity was improved by arranging the Mg vapor-deposited foil on the side of the negative electrode current collector layer and arranging the Ga vapor-deposited foil as the second negative electrode active material layer between the Mg vapor-deposited foil and the solid electrolyte layer.

1. A solid-state battery in which a positive electrode collector layer, a positive electrode active material layer, a solid electrolyte layer, a negative electrode active material layer, and a negative electrode collector layer are laminated in this order,
wherein the negative electrode active material layer comprises a gallium-based layer containing gallium or lithium-gallium alloy, and a magnesium-based layer containing magnesium or lithium-magnesium alloy,
wherein the gallium-based layer is arranged on the side of the solid electrolyte layer, and
wherein the magnesium-based layer is arranged on the side of the negative electrode collector layer.

2. The solid-state battery according to claim 1, wherein in a charged state, the gallium-based layer contains the lithium-gallium alloy, and the magnesium-based layer contains the lithium-magnesium alloy.

3. The solid-state battery according to claim 1, wherein in a discharged state, the gallium-based layer contains the gallium, and the magnesium-based layer contains the magnesium.

4. The solid-state battery according to claim 1, wherein the negative electrode active material layer is composed only of the gallium-based layer and magnesium-based layer.

5. The solid-state battery according to claim 1, wherein the solid electrolyte layer is a sulfide solid electrolyte layer.

6. The solid-state battery according to claim 1, wherein the gallium-based layer and the magnesium-based layer are gallium-magnesium bilayer vapor-deposited foils.
